(19) United States
(12) Patent Application Publication
(10) Pub. No.: US 2015/0277004 A1
(43) Pub. Date: Oct. 1, 2015

(54) DISPLAY DEVICE AND ELECTRONIC APPARATUS

(71) Applicant: Sony Corporation, Tokyo (JP)

(72) Inventor: Mamoru Suzuki, Kanagawa (JP)

(21) Appl. No.: 14/656,026

(22) Filed: Mar. 12, 2015

(30) Foreign Application Priority Data
Mar. 31, 2014 (JP) 2014-073783

(51) Int. Cl. G02B 5/22

(52) U.S. Cl. CPC G02B 5/223

(57) ABSTRACT

A display device includes a display unit that includes a first pixel and a second pixel which are adjacent to each other in a first direction and a filter layer that includes a first filter and a second filter which are disposed corresponding to each of the first pixel and the second pixel, and which are adjacent to each other in the first direction, in which a refractive index of the first filter is lower than a refractive index of the second filter, a dimension of at least a part of the first filter in the first direction is larger than a dimension of the second filter in the first direction, and at least a portion of a boundary between the first filter and the second filter is positioned in an area occupied by the second pixel.

### CROSS REFERENCE TO RELATED APPLICATIONS

This application claims the benefit of Japanese Priority Patent Application JP 2014-073783 filed Mar. 31, 2014, the entire contents of which are incorporated herein by reference.

### BACKGROUND

The present disclosure relates to a display device including a color filter, and an electronic apparatus including the display device.

A light emitting element such as an organic EL element includes a light emitting layer between a first electrode and a second electrode, and emits light by a recombination of a positive hole and an electron in the light emitting layer when a direct current voltage is applied to the light emitting layer. As the display device including a plurality of the organic EL elements, a display device, which displays each color light by causing all of the organic EL elements to generate white light, and causing the white light to be transmitted through a color filter through which a predetermined wave length of light is selectively transmitted for each pixel, has been generally used (for example, refer to Japanese Unexamined Patent Application Publication No. 2013-37808).

### SUMMARY

However, in a structure in which color separation is performed by using a color filter, since white light is obliquely incident on the color filter from an organic EL element, there is a possibility that color blur is generated in the vicinity of a boundary between adjacent pixels. Therefore, it can be considered to provide a light shielding portion, which is called a black matrix, on the emission side of the color filter; however, in this case, there is a concern in that luminance of the entire screen is reduced or a viewing angle characteristic is deteriorated.

It is desirable to provide a display device having excellent display performance in which mixed colors and color blurs are reduced without damaging the viewing angle characteristics, and an electronic apparatus including the display device.

According to an embodiment of the present disclosure, there is provided a display device including a display unit that includes a first pixel and a second pixel which are adjacent to each other in a first direction and a filter layer that includes a first filter and a second filter which are disposed corresponding to each of the first pixel and the second pixel, and which are adjacent to each other in the first direction, in which a refractive index of the first filter is lower than a refractive index of the second filter, a dimension of at least a part of the first filter in the first direction is larger than a dimension of the second filter in the first direction, and at least a portion of a boundary between the first filter and the second filter is positioned in an area corresponding to the second pixel.

According to an embodiment of the present disclosure, there is provided an electronic apparatus including the display device.

In the display device according to the embodiment of the present disclosure, the refractive index of the first filter corresponding to the first pixel may be lower than the refractive index of the second filter corresponding to the second pixel. In addition, the dimension of at least a part of the first filter in the first direction may be larger than the dimension of the second filter in the first direction, and at least a portion of the boundary between the first filter and the second filter may be positioned in an area corresponding to the second pixel. For this reason, it is possible to prevent the light which is incident on the second filter from the second pixel from entering the first filter.

In the display device and the electronic apparatus according to the embodiments of the disclosure, since mixed colors or color blurs which occurs in the vicinity of the boundary between the first pixel and the second pixel are reduced without causing the viewing angle characteristics to be deteriorated, it is possible to achieve excellent display performance. Meanwhile, effects of the present disclosure are not limited thereto and may be any of the effect of the following description.

### BRIEF DESCRIPTION OF THE DRAWINGS

FIG. 1 is a cross-sectional view illustrating main components of a display device according to a first embodiment of the present disclosure;

FIG. 2 is an overall structure illustrating the display device as illustrated in FIG. 1;

FIG. 3 is a diagram illustrating an example of a pixel driving circuit illustrated in FIG. 2;

FIG. 4 is a top view illustrating of the main components the display device as illustrated in FIG. 1;

FIG. 5 is explanatory diagram illustrating an operation in the display device as illustrated in FIG. 1;

FIG. 6A is a characteristic diagram illustrating a relationship of refractive indexes satisfying conditions of total reflection in the display device illustrated in FIG. 1;

FIG. 6B is another characteristic diagram illustrating a relationship of refractive indexes satisfying conditions of total reflection in the display device illustrated in FIG. 1;

FIG. 7 is a cross-sectional view illustrating main components of a display device according to a second embodiment of the disclosure;

FIG. 8A is a top view illustrating the main components of the display device as illustrated in FIG. 7;

FIG. 8B is an enlarged top view illustrating a portion of the main components of the display device as illustrated in FIG. 8A;

FIG. 9 is an explanatory diagram illustrating an operation in the display device as illustrated in FIG. 7;

FIG. 10A is a first characteristic diagram relating to conditions in which light does not leak from a color filter having a relatively low refractive index to a color filter having a relatively high refractive index in the display device as illustrated in FIG. 7;

FIG. 10B is a second characteristic diagram relating to conditions in which light does not leak from a color filter having a relatively low refractive index to a color filter having a relatively high refractive index in the display device as illustrated in FIG. 7;

FIG. 11 is a cross-sectional view illustrating main components of a display device according to a third embodiment of the disclosure;

FIG. 12 is a top view illustrating a schematic configuration of a module including the display device according to the first embodiment to the third embodiment;

FIG. 13 is a perspective view illustrating the appearance of a smart phone as an application example of the display device according to the first embodiment to the third embodiment;

FIG. 14 is a cross-sectional view illustrating main components of a display device as a first modification example of the disclosure;

FIG. 15A is a cross-sectional view illustrating a partial configuration of a display device as a second modification example of the disclosure;

FIG. 15B is a cross-sectional view illustrating a partial configuration of a display device as a third modification example of the disclosure;

FIG. 15C is a cross-sectional view illustrating a partial configuration of a display device as a fourth modification example of the disclosure;

FIG. 16A is a cross-sectional view illustrating a partial configuration of a display device as a fifth modification example of the disclosure;

FIG. 16B is a cross-sectional view illustrating a partial configuration of a display device as a sixth modification example of the disclosure;

FIG. 16C is a cross-sectional view illustrating a partial configuration of a display device as a seventh modification example of the disclosure; and

FIG. 17 is an explanatory diagram illustrating an operation in the display device as a comparative example.

### DETAILED DESCRIPTION OF EMBODIMENTS

Hereinafter, description is given of embodiments of the present disclosure in detail with reference to the drawings. In addition, the description will be made in the following order.

1. First embodiment (a display device of a basic configuration: a top emission type)
2. Second embodiment (a display device further includes a shielding layer: a top emission type)
3. Third embodiment (a display device: a bottom emission type)
4. Application example of display device (a module and a smart phone)
5. Modification examples
(1) Example of shielding layer being disposed inside color filter
(2) Modification example of color filter having planar shape

### 1. First Embodiment

### Configuration of Display Device 1

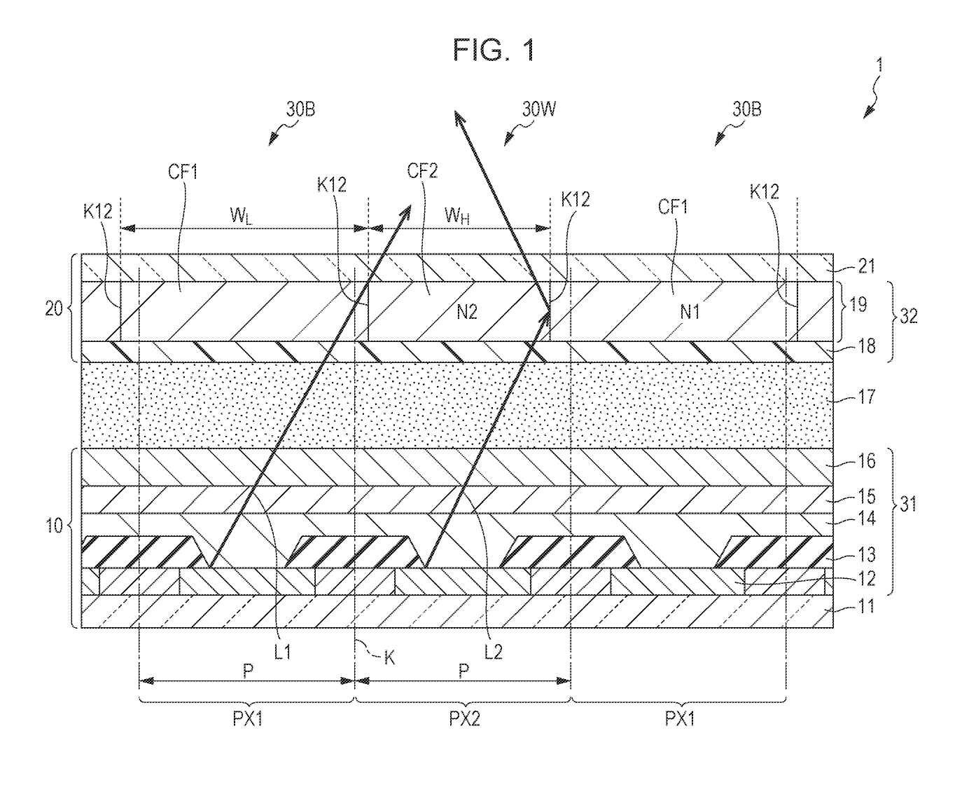

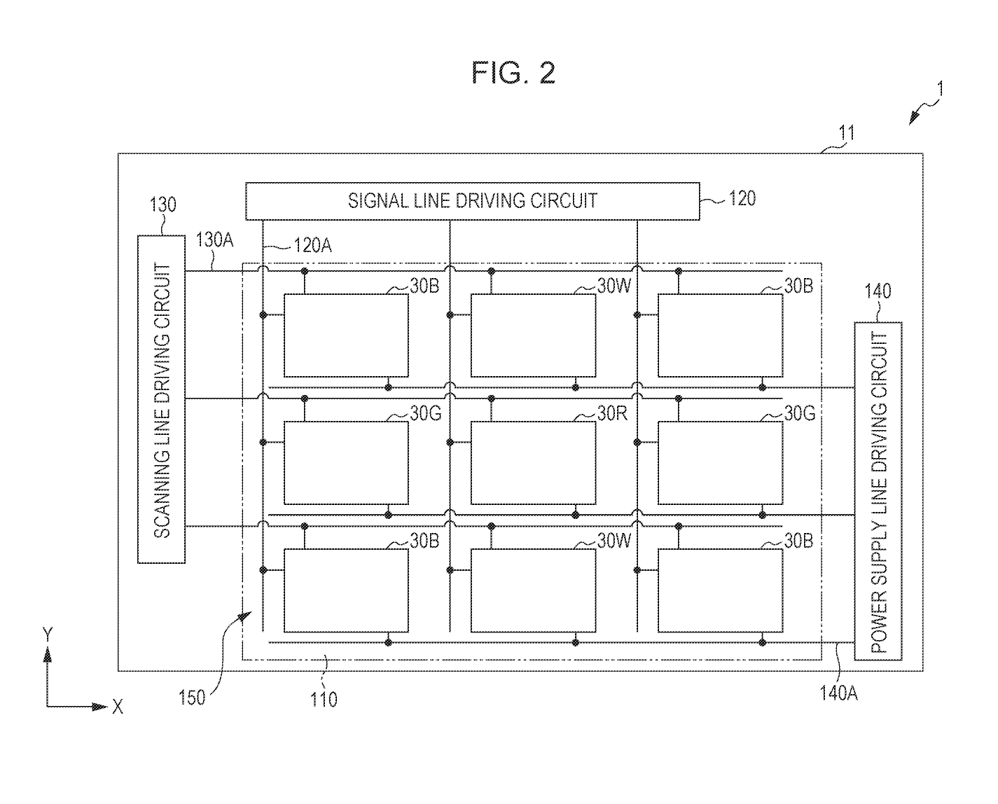

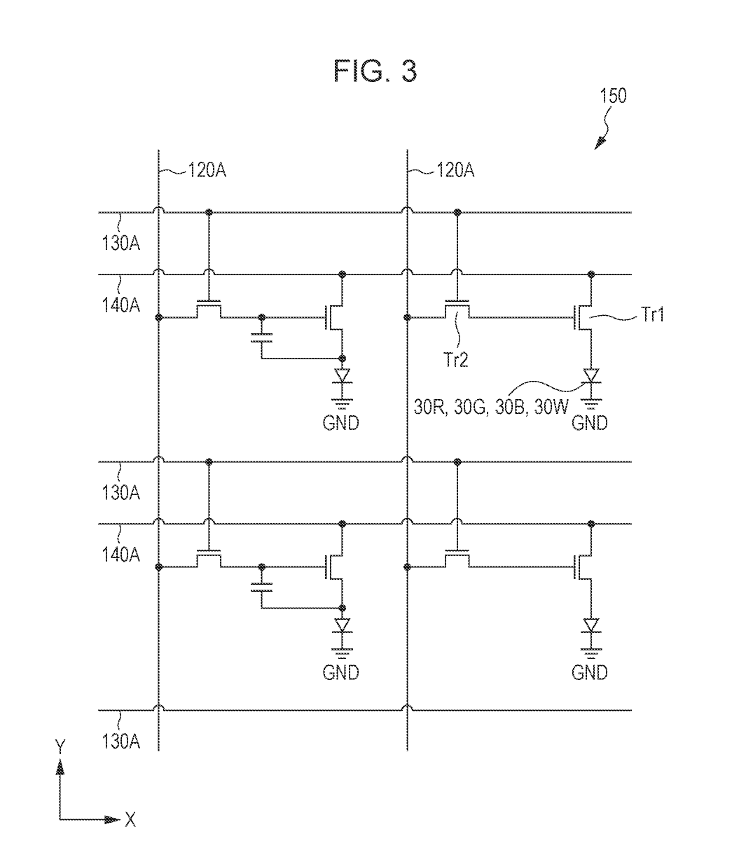

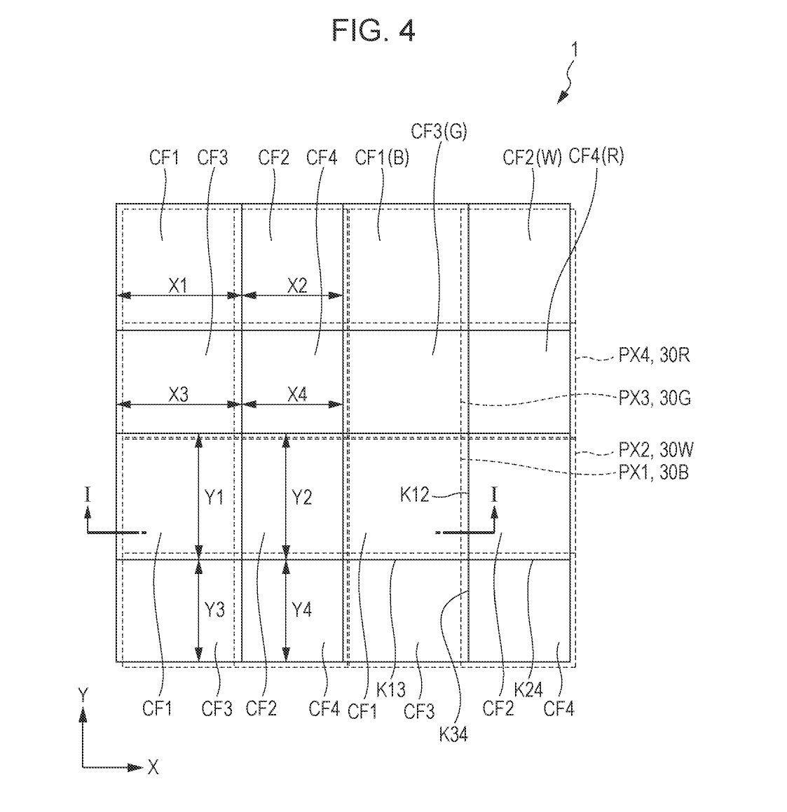

With reference to FIG. 1 to FIG. 4, as a first embodiment in the disclosure, an organic EL display device (the display device 1) will be described. FIG. 1 is a cross-sectional view illustrating main components of the display device 1. FIG. 2 is an overall structure illustrating the display device 1. FIG. 3 is a diagram illustrating a configuration example of a pixel driving circuit 150 (described later) included in the display device 1. FIG. 4 is a top view illustrating the main components the display device 1. Meanwhile, FIG. 1 corresponds to a cross-sectional view taken along line I-I in an arrow direction illustrated in FIG. 4. The display device 1, which includes an element panel 10 and a sealing panel 20 and is a so-called top emission-type display device extracting light which is transmitted through the sealing panel 20, includes a plurality of organic light emitting elements 30. Examples of the organic light emitting element 30 include organic light emitting elements 30R, 30G, 30B, and 30W which respectively emit red light, green light, blue light, and, white light.

As illustrated in FIG. 1, the element panel 10 is provided with a substructure 31 of the organic light emitting elements 30R, 30G, 30B, and 30W on an element substrate 11. The substructure 31 of each of the organic light emitting elements 30R, 30G, 30B, and 30W is configured to have a first pixel PX1 to a fourth pixel PX4 (FIG. 4), and has a stacking structure formed of, for example, a first electrode layer 12, an organic layer 14, a second electrode layer 15, and a protective film 16. All the respective components of substructure 31 are covered with an adhesive layer 17 which is provided between a sealing panel 20 and the substructure 31. The sealing panel 20 is formed of a sealing substrate 21 facing the element substrate 11, and, as a superstructure 32 of the organic light emitting elements 30R, 30G, 30B, and 30W, a color filter (CF) layer 19 and an overcoat layer 18 are provided in order on a surface of which the sealing substrate 21 faces the element substrate 11. Here, the substructure 31 of each of the organic light emitting elements 30R, 30G, 30B, and 30W includes, for example, the organic layer 14, the second electrode layer 15, and the protective film 16 which are common components and emit the white light. In addition, the CF layer 19 color-separates the white light emitted from the substructure 31 of each of the organic light emitting elements 30R, 30G, 30B, and 30W to red light, green light, blue light, and the white light. In addition, FIG. 1 illustrates only the organic light emitting elements 30B and 30W.

As illustrated in FIG. 2, a display area 110 in which the organic light emitting elements 30R, 30G, 30B, and 30W are disposed in a two-dimensional matrix shape is positioned in the center portion of the display device 1. Drivers for displaying an image, for example, a signal line driving circuit 120, a scanning line driving circuit 130, and a power supply line driving circuit 140 are provided in the periphery of the display area 110.

The display area 110 is formed of the plurality of organic light emitting elements 30R, 30G, 30B, and 30W and the pixel driving circuit 150 for driving the plurality of organic light emitting elements. In the pixel driving circuit 150, a plurality of signal lines 120A (120A1, 120A2, . . . , 120Am, . . . ) are disposed in the column direction (in the Y direction), and a plurality of scanning lines 130A (130A1, . . . , 130An, . . . ) and a plurality of power supply lines 140A (140A1, . . . , 140An, . . . ) are disposed in the row direction (in the X direction). The organic light emitting elements 30R, 30G, 30B, and 30W are respectively provided at an intersection between the signal line 120A and the scanning line 130A. Both ends of the signal line 120A are connected to the signal line driving circuit 120, both ends of the scanning line 130A are connected to the scanning line driving circuit 130, and both ends of the power supply line 140A are connected to the power supply line driving circuit 140.

The signal line driving circuit 120 supplies a signal voltage of an imaging signal which is supplied from a signal supply source (not shown) in response to luminance information to the selected organic light emitting elements 30R, 30G, 30B, and 30W via the signal line 120A. The scanning line driving circuit 130 includes a shift register for sequentially shifting (transmitting) a start pulse in synchronization with a clock pulse to be input. When the imaging signal is written into each of the organic light emitting elements 30R, 30G, 30B, and 30W, the scanning line driving circuit 130 sequentially supplies the scanning signals to each scanning line 130A by scanning the written imaging signals by a row unit. The signal voltage from the signal line driving circuit 120 is supplied to the signal line 120A, and the scanning signal of the scanning line driving circuit 130 is supplied to the scanning line 130A.

The power supply line driving circuit 140 includes the shift register for sequentially shifting (transmitting) a start pulse in synchronization with a clock pulse to be input. The power supply line driving circuit 140 properly supplies any one of a first potential and a second potential which are different from each other to each power supply line 140A from both ends thereof in synchronization with the scanning performed through the scanning line driving circuit 130 by the row unit. Due to this, a selection of a conduction state or a non-conduction state of a transistor Tr1 described later is performed.

As illustrated in FIG. 3, the pixel driving circuit 150 is an active-type driving circuit which includes the transistor Tr1 and a transistor Tr2, a capacitor (storage capacitor) Cs, and the organic light emitting elements 30R, 30G, 30B, and 30W. The organic light emitting elements 30R, 30G, 30B, and 30W are connected to the transistor Tr1 in series between the power supply line 140A and a common power supply line (GND). The transistor Tr1 and the transistor Tr2 may be an inverse-staggered structure (a so called bottom type) and may be a stagger structure (the top gate type).

For example, a drain electrode of the transistor Tr2 is connected to the signal line 120A and an imaging signal from the signal line driving circuit 120 is supplied to the drain electrode. In addition, a gate electrode of the transistor Tr2 is connected to the scanning line 130A, and the scanning signal from the scanning line driving circuit 130 is supplied to the gate electrode. Further, a source electrode of the transistor Tr2 is connected to a gate electrode of a driving transistor Tr1.

For example, a drain electrode of the transistor Tr1 is connected to the power supply line 140A, and is set to either the first potential or the second potential by the power supply line driving circuit 140. The source electrode of the transistor Tr1 is connected to the organic light emitting elements 30R, 30G, 30B, and 30W.

The storage capacitor Cs is formed between the gate electrode of the transistor Tr1 (the source electrode of the transistor Tr2) and the source electrode of the transistor Tr1.

### Main Components of Display Device 1

Next, with reference to FIG. 1 again, configurations of the element panel 10 and the sealing panel 20 will be described in detail.

The element substrate 11 is formed of, for example, a plastic or glass material which is capable of shielding transmission of moisture (water vapor) and oxygen. The element substrate 11 is a support having a main surface on which organic light emitting elements 10R, 10G, and 10B are disposed. Examples of materials for forming the element substrate 11 include a glass substrate such as high strain point glass, soda glass (Na₂O.CaO.SiO₂), borosilicate glass (Na₂O.B₂O₃.SiO₂), forsterite (2MgO.SiO₂), lead glass (Na₂O.PbO.SiO₂), or the like, a quartz substrate, and the silicon substrate. The element substrate 11 may be formed by providing an insulating film on the surface of the glass substrate, the quartz substrate, and the silicon substrate. The element substrate 11 may be formed by using metallic foil, or a resin film or sheet. Examples of resin materials include an organic polymer such as polymethyl methacrylate (polymethyl methacrylate, PMMA), polyvinyl alcohol (PVA), polyvinyl phenol (PVP), polyether sulfone (PES), polyimide, polycarbonate, polyethylene terephthalate (PET), and polyethylene naphthalate (PEN). Meanwhile, in the top emission type, since the light is extracted from the sealing substrate 21, the element substrate 11 may be formed of a transmission material or a non-transmission material. The sealing substrate 21 may be formed of the same material as the element substrate 11 or may be formed of the different material from the element substrate 11. In addition, the element substrate 11 may be formed of a flexible material.

The organic light emitting elements 30R, 30G, 30B, and 30W are formed by stacking the first electrode layer 12, the organic layer 14 including a light emitting layer, the second electrode layer 15, the protective film 16, the adhesive layer 17 which is a sealing layer, the overcoat layer 18, and the CF layer 19 in order on the element substrate 11. An insulating film 13 is disposed between the organic light emitting elements 30R, 30G, 30B, and 30W which are adjacent to each other. The arrangement of the organic light emitting elements 30R, 30G, 30B, and 30W is not particularly limited. For example, a striped arrangement or a diagonal arrangement can be adopted in addition to the rectangular arrangement illustrated in FIG. 2 and FIG. 4 (described later).

Since the first electrode layer 12 is provided corresponding to each of the organic light emitting elements 30R, 30G, 30B, and 30W, the plurality of first electrode layers 12 are provided to be separated from each other on the element substrate 11. The first electrode layer 12 which has, for example, a function as an anode electrode and a function as a reflecting layer, is preferably formed of a material having high reflectivity and high positive hole injection properties. Examples of such a first electrode layer 12 include a simple substance of a metallic element such as chromium (Cr), gold (Au), platinum (Pt), nickel (Ni), copper (Cu), molybdenum (Mo), tungsten (W), titanium (Ti), tantalum (Ta), aluminum (Al), iron (Fe), and silver (Ag), or an alloy thereof. The first electrode layer 12 may be formed by stacking a plurality of metallic films as listed above. In addition, the first electrode layer 12 may be formed by using an Ag—Pd—Cu alloy which is formed by having silver contain 0.3 weight % to 1 weight % of palladium (Pd) and 0.3 weight % to 1 weight % of copper, or may be formed by using an alloy Al-neodymium (Nd). The first electrode layer 12 is preferably formed by using a material having excellent work function, but metal such as aluminum and an aluminum alloy having a low work function can be used to form the first electrode layer 12 after selecting the proper organic layer 14 (particularly, a positive hole injection layer described later).

Both side surfaces of the first electrode layer 12 (facing surface of the second electrode layer 15) are covered with the insulating film 13, and openings which regulates an emitting area of the organic light emitting elements 30R, 30G, 30B, and 30W are provided on the insulating film 13. The insulating film 13 functions to control the emitting area to be formed into an accurately desired shape, and functions to secure insulation properties between the first electrode layer 12 and the second electrode layer 15. The insulating film 13 may be formed by using an organic material, for example, polyimide, or an inorganic material such as silicon oxide (SiO₂), silicon nitride (SiNx), and silicon oxide nitride (SiON).

The organic layer 14 is commonly provided in, for example, all of the organic light emitting elements 30R, 30G, 30B, and 30W, and a positive hole injection layer, a positive hole transport layer, a light emitting layer, an electron transport layer, and an electron injection layer (which are not shown) are provided in order from the first electrode layer 12 side. The organic layer 14 may be formed of the positive hole transport layer, the light emitting layer, and the electron transport layer, and at this time, the light emitting layer may function as the electron transport layer. The organic layer 14 may be formed by stacking a series of the stacking structures (a so-called tandem unit) via a connection layer. For example, each color of red, green, and blue has the tandem unit, and thus may be stacked to form the organic layer 14.

The positive hole injection layer for improving injection efficiency of the positive hole is a buffer layer for preventing leakage. The positive hole injection layer is formed of, for example, a hexa-aza triphenylene derivative as shown in Chem. 1 or Chem. 2.

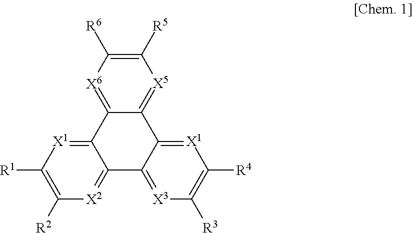

(in Chem. 1, each of R1 to R6 is a substituted group independently selected from hydrogen, halogen, a hydroxyl group, an amino group, an arylamino group, a substituted or unsubstituted carbonyl group having 20 or fewer of carbon atoms, a substituted or unsubstituted carbonyl ester group having 20 or fewer of carbon atoms, a substituted or unsubstituted alkyl group having 20 or fewer of carbon atoms, a substituted or unsubstituted alkenyl group having 20 or fewer of carbon atoms, a substituted or unsubstituted alkoxyl group having 20 or fewer of carbon atoms, a substituted or unsubstituted aryl group having 30 or fewer of carbon atoms, a substituted or unsubstituted heterocyclic group having 30 or fewer of carbon atoms, a nitrile group, a cyano group, a nitro group, or a silyl group, and Rms (m=1 to 6) which are adjacent to each other may be combined with each other in a cyclic structure. In addition, each of X1 to X6 denotes a carbon atom or a nitrogen atom.)

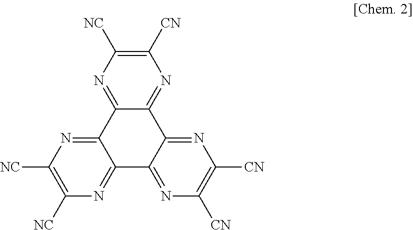 [SMILES: N#Cc1nc2c3nc(C#N)c(C#N)nc3c3nc(C#N)c(C#N)nc3c2nc1C#N]

The positive hole transport layer functions to improve efficiency of the positive hole being transported to the light emitting layer. The positive hole transport layer has the thickness of about 40 nm, and is formed of, for example, 4,4′,4″-tris(3-methyl-phenyl-phenylamino)triphenylamine (m-MTDATA) or α-naphthyl phenyl diamine (αNPD).

The light emitting layer is the light emitting layer for emitting for example white light and has a stacked body which is formed of, for example, a red light emitting layer, a green light emitting layer, and a blue light emitting layer (which are not shown) is provided between the first electrode layer 12 and the second electrode layer 15. If voltage is applied to the red light emitting layer, the green light emitting layer, and the blue light emitting layer, some of the positive holes which are injected from the first electrode layer 12 via the positive hole injection layer and the positive hole transport layer and some of the electrons injected from the second electrode layer 15 via the electron injection layer and the electron transport layer are recombined with each other, and thereby red light, green light, and blue light are generated.

A red light emitting layer contains at least one type of, for example, a red light emitting material, a positive hole transport material, an electron transport material, and both charge transport materials. The red light emitting material may be a fluorescent material or a phosphorescent material. The red light emitting layer has the thickness of about 5 nm, and is formed by mixing, for example, 30 weight % of 2,6-bis[(4′-methoxydiphenyl amino) styryl]-1,5-dicyanonaphthalen (BSN) to 4,4-bis (2,2-diphenylvinyl) biphenyl (DPVBi).

A green light emitting layer contains at least one type of, for example, a green light emitting material, a positive hole transport material, an electron transport material, and both charge transport materials. The green light emitting material may be the fluorescent material or the phosphorescent material. The green light emitting layer has the thickness of about 10 nm, and is formed by mixing, for example, 5 weight % of coumarin 6 into DPVBi.

A blue light emitting layer contains at least one type of, for example, a blue light emitting material, a positive hole transport material, an electron transport material, and both charge transport material. The blue light emitting material may be the fluorescent material or the phosphorescent material. The blue light emitting layer has the thickness of about 30 nm, and is formed by mixing, for example, 2.5 weight % of 4,4′-bis[2-{4-(N,N-diphenyl amino)phenyl}vinyl]biphenyl(DPAVBi) to DPVBi.

The electron transport layer for improving the efficiency of the electrons being transported to the light emitting layer is formed of, for example, 8-hydroxyquinoline aluminum (Alq₃) having the thickness of about 20 nm. The electron injection layer for improving efficiency of the electrons being injected to the light emitting layer is formed of, for example, LiF or Li₂O which has the thickness of about 0.3 nm.

The second electrode layer 15 is paired with the first electrode layer 12 by interposing the organic layer 14 therebetween and, for example, is provided on the electron injection layer in common with the organic EL element 30R, 30G, 30B, 30W. The second electrode layer 15 which has, for example, a function of as a cathode electrode and a function as a light transmission layer, is preferably formed of a material having high conductivity and high transmittance of light. Accordingly, the second electrode layer 15 is formed of, for example, and alloy of aluminum (Al), magnesium (Mg), silver (Ag), calcium (Ca), or sodium (Na). Among them, an alloy of magnesium and silver (Mg—Ag alloy) is preferable because it has the smallness of the absorption and conductivity of a thin film as well. In addition, Examples of a material for the second electrode layer 15 may include an alloy of aluminum (Al) and lithium (Li) (an Al—Li alloy), or may include indium tin oxide (ITO), zinc oxide (ZnO), aluminium-doped zinc oxide (AZO), gallium-doped zinc oxide (GZO), indium zinc oxide (IZO), indium titanium oxide (ITiO), indium tungsten oxide (IWO), or the like. The second electrode layer 15 has a function of preventing water penetration into the organic layer 14.

The adhesive layer 17 seals a gap between the element panel 10 and the sealing panel 20 by covering the entire surface of the element panel 10 such that the second electrode layer 15 is covered. The adhesive layer 17 functions to prevent water penetration to the display area 110 from the outside and regulate the distance between the element panel 10 and the sealing panel 20. The adhesive layer 17 is formed of a transparent resin such as a thermosetting adhesive or an ultraviolet ray curable adhesive. Examples of the adhesive include an acrylic-based adhesive, an epoxy-based adhesive, a urethane-based adhesive, a silicone-based adhesive, or a cyanoacrylate-based adhesive.

The overcoat layer 18 is a coating agent for improving the surface flatness of the CF layer 19 and protecting the surface of the CF layer 19, and is formed of an organic material such as resin or an inorganic material such as SiO, SiN, or ITO.

The CF layer 19 includes, for example, a first filter CF1 to a fourth filter to CF4, and these filters are color-arranged for each pattern of the organic light emitting elements 30R, 30G, 30B, and 30W, and are disposed in a rectangular manner. Specifically, as illustrated in FIG. 4, the first filter CF1 is a blue (B) filter, the second filter CF2 is a white (W) filter, the third filter CF3 is a green (G) filter, and the fourth filter CF4 is a red (R) filter. The white light from the substructure 31 of each of the organic light emitting elements 30R, 30G, 30B, and 30W is transmitted through the first to fourth filters CF1 to CF4, and thus each of the red light, the green light, the blue light, and the white light is emitted. The first to fourth filters CF1 to CF4 are respectively disposed to correspond to a first pixel PX1 to a fourth pixel to PX4. Here, the first pixel PX1 is formed of an organic light emitting element 30B, the second pixel PX2 is formed of an organic light emitting element 30W, the third pixel PX3 is formed of an organic light emitting element 30G, and the fourth pixel PX4 is formed of an organic light emitting element 30R.

According to the embodiment, the first filter CF1 and the second filter CF2 which are adjacent to each other in the first direction (the X axial direction) are respectively disposed to correspond to the first pixel PX1 and the second pixel PX2. Similarly, the third filter CF3 and the fourth filter CF4 which are adjacent to each other in the X axial direction are respectively disposed to correspond to the third pixel PX3 and the fourth pixel PX4. In addition, the first filter CF1 and the third filter CF3 are adjacent to each other, and the second filter CF2 and the fourth filter CF4 are adjacent to each other in the second direction (the Y axial direction).

A refractive index N1 of the first filter CF1 is lower than both of a refractive index N2 of the second filter CF2 and a refractive index N3 of the third filter CF3 (N1<N2 and N1<N3). In addition, a refractive index N4 of the fourth filter CF4 is higher than both of the refractive index N2 of the second filter CF2 and the refractive index N3 of the third filter CF3 (N2<N4, N3<N4). Meanwhile, the refractive index represents an average value with respect to visible light (400 nm to 700 nm). For example, the refractive index N1 is 1.50, the refractive index N2 is 1.55, the refractive index N3 is 1.65, and the refractive index N4 is 1.75.

In addition, a dimension X1 of the first filter CF1 in the X axial direction is larger than a dimension X2 of the second filter CF2 in the X axial direction (X1>X2), and a boundary K12 between the first filter CF1 and the second filter CF2 is positioned in an area occupied by the second pixel PX2. Similarly, a dimension X4 of the fourth filter CF4 in the X axial direction is smaller than a dimension X3 of the third filter CF3 in the X axial direction (X3>X4), and a boundary K34 between the third filter CF3 and the fourth filter CF4 is positioned in an area occupied by the fourth pixel PX4.

Further, a dimension Y1 of the first filter CF1 in the Y axial direction is larger than a dimension Y3 of the third filter CF3 in the Y axial direction (Y1>Y3), and a boundary K13 between the first filter CF1 and the third filter CF3 is positioned in an area occupied by the third pixel PX3. Similarly, a dimension Y4 of the fourth filter CF4 in the Y axial direction is smaller than a dimension Y2 of the second filter CF2 in the Y axial direction (Y2>Y4), a boundary K24 between the second filter CF2 and the fourth filter CF4 is positioned in an area occupied by the fourth pixel PX4.

The first to fourth filters CF1 to CF4 are formed of, for example, resin mixed with a pigment or a dye. The transmissivity of a wavelength region of red, green, or blue is adjusted to be high in each of a red filter, a green filter, and a blue filter by properly selecting the type of the pigment or the dye.

### Operation of Display Device 1

In the display device 1, when a driving current in response to each color of imaging signal is applied to each of the organic light emitting elements 30R, 30G, 30B, and 30W, the electron and the positive hole are injected into the organic layer 14 through the first electrode layer 12 and the second electrode layer 15. The electron and the positive hole are recombined with each other in the light emitting layer which is included in the organic layer 14, and thereby the light is emitted. The emitted light is extracted to the outside by being transmitted through the second electrode layer 15, the protective film 16, the adhesive layer 17, the overcoat layer 18, the CF layer 19, and the sealing substrate 21 in order. In this manner, a full color image based on the color light such as R, G, B, and W is displayed on the display device 1. In addition, at the time of this image display operation, if a potential corresponding to an imaging signal is applied to an end of a capacitance element Cs, an electrical charge corresponding to the imaging signal is accumulated to the capacitance element Cs.

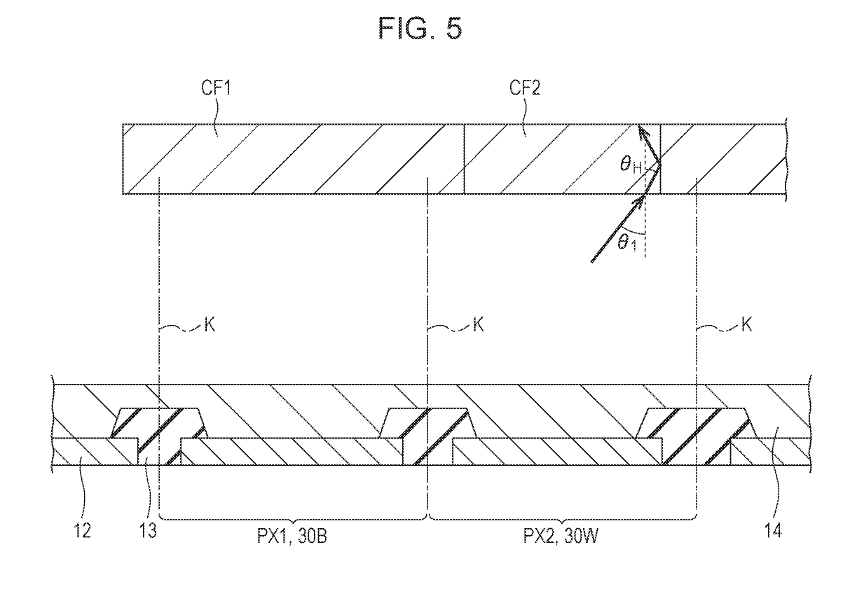

Meanwhile, for example, the relationship between the first filter CF1 (a filter having a relatively low refractive index) and the second filter CF2 (a filter having a relatively high refractive index) is desired to satisfy Condition Expression (1) as shown in the following Formula 1 (refer to FIG. 5). This is because that the light which is incident on the second filter CF2 from the second pixel PX2 is totally reflected and thus the light is securely prevented from entering the first filter CF1 from the boundary K12. Here, n1 represents a refractive index of a medium through which the light passes immediately before being incident on the second filter CH2 from the second pixel PX2, that is, a refractive index of the overcoat layer 18, nH represents a refractive index of the second filter CF2, θ1 represents a maximum angle of incidence of the light which is incident on the second filter CF2 from the second pixel PX2, and nL (nL<nH) represents a refractive index of the first filter CF1.

$$\begin{matrix}[ Formula 1 ] & \\ {sin}^{- 1} ( \frac{{n}_{1}}{{n}_{H}} sin {θ}_{1} ) + {sin}^{- 1} ( \frac{{n}_{L}}{{n}_{H}} ) ≦ \frac{π}{2} & ( 1 )\end{matrix}$$

Meanwhile, Condition Expression (1) is obtained as follows. First, a refracting angle θH (refer to FIG. 5) of the light incident on the second filter CF2 is illustrated by using Expression (1.1) shown in the following Formula 2.

$$\begin{matrix}[ Formula 2 ] & \\ {θ}_{H} = {sin}^{- 1} ( \frac{{n}_{1} sin {θ}_{1}}{{n}_{H}} ) & ( 1.1 )\end{matrix}$$

In addition, a critical angle θC between the second filter CF2 and the first filter CF1 is illustrated by using Expression (1.2) shown in the following Formula 3.

$$\begin{matrix}[ Formula 3 ] & \\ {θ}_{C} = {sin}^{- 1} ( \frac{{n}_{L}}{{n}_{H}} ) & ( 1.2 )\end{matrix}$$

In addition, a condition for causing the light propagating in the second filter CF2 to be totally reflected in the boundary between the first filter CF1 and the second filter CF2 is illustrated by using Expression (1.3) shown in the following Formula 4.

$$\begin{matrix}[ Formula 4 ] & \\ {θ}_{H} \leq \frac{π}{2} {θ}_{c} & ( 1.3 )\end{matrix}$$

Using the aforementioned Expressions (1.1) to (1.3), Condition Expression (1) illustrated in the above described Formula 1 is obtained.

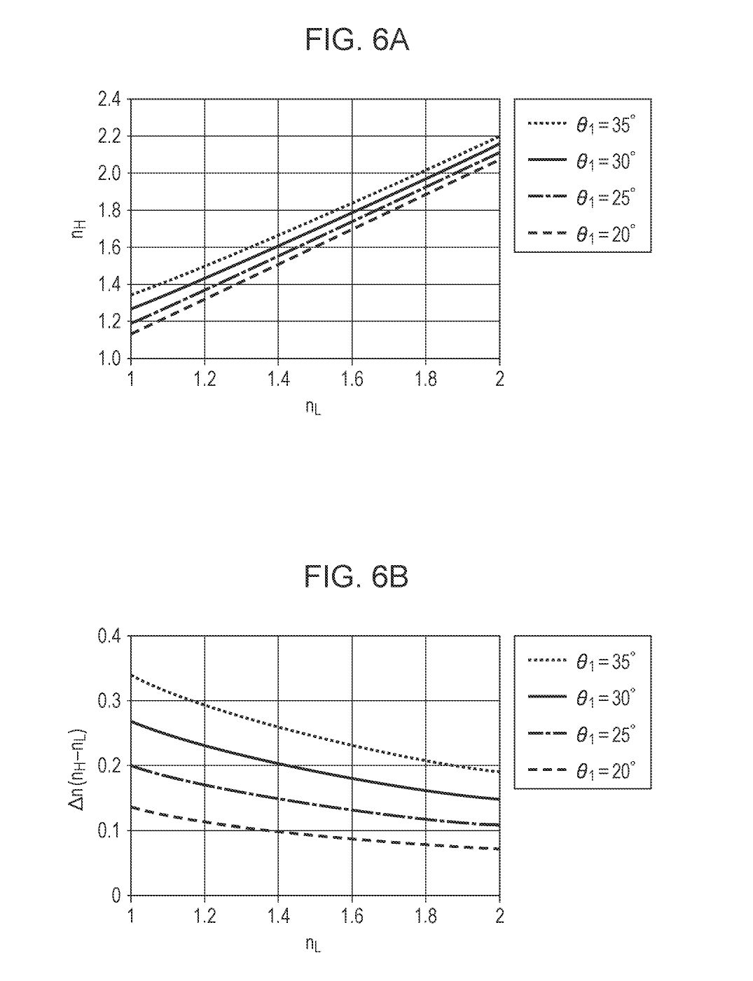

In addition, as illustrated in FIGS. 6A and 6B, in order to set the refractive index N2 (nH) of the second filter CF2 to be low, it is desirable that the refractive index N1 (nL) of the first filter CF1 is set to be as high as possible, and the maximum angle of incidence θ1 is set to be as small as possible. In addition, FIG. 6A is a characteristic diagram illustrating a minimum value of refractive index N2 (nH) satisfying Condition Expression (1) in the respective levels in which a horizontal axis represents the refractive index N1 (nL), a vertical axis represents the refractive index N2 (nH), and each curved line represents the maximum angle of incidence θ1=20°, 25°, 30°, and 35°. In addition, FIG. 6B is a characteristic diagram in which the vertical axis of FIG. 6A is changed to a difference do (nH−nL) between the refractive index N2 (nH) and the refractive index N1 (nL).

### Effects of Display Device 1

The display device 1 is configured such that the CF layer 19 includes the first to fourth filters CF1 to CF4 which are disposed corresponding to the first to fourth pixels PX1 to PX4 and have the refractive indexes N1 to N4 which are different from each other (note that, the refractive index N2 and the refractive index N3 may be matched with each other). For this reason, in light L2 which is transmitted through a filter (for example, CF2) having a relatively high refractive index, the light which enters an adjacent filter (for example, CF1) having a relatively low refractive index can be reduced. Particularly, in a case of satisfying the above described Condition Expression (1), it is possible to reliably prevent the leakage light.

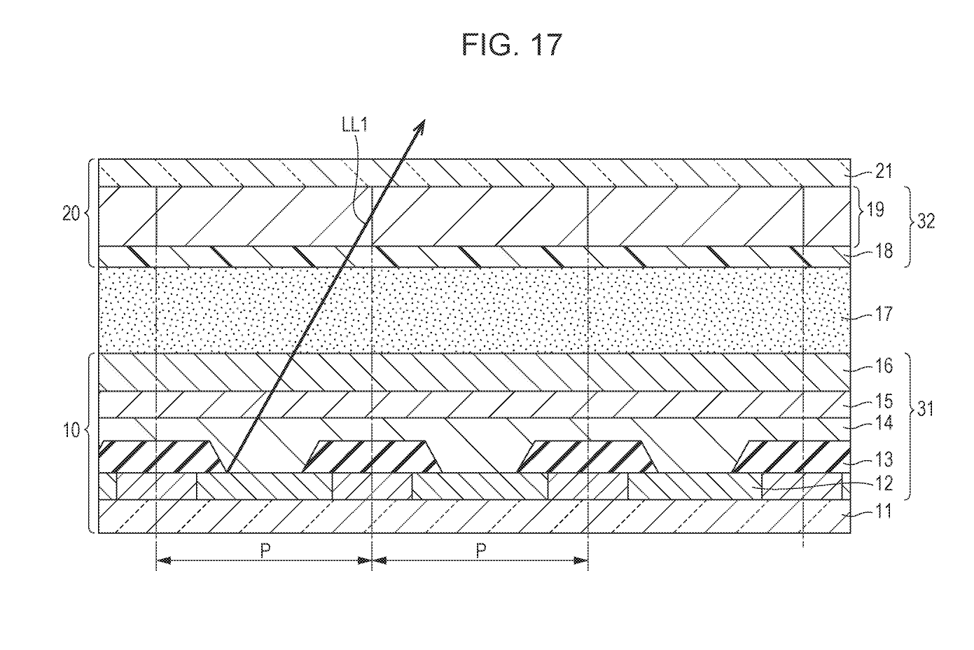

In addition, the boundary (K12) between the filter (for example, CF1) having the relatively low refractive index and the filter (for example, CF2) having the relatively high refractive index which are adjacent to each other is positioned in an area which is equivalent to the pixel (PX2) corresponding to the filter having the relatively high refractive index (CF2). Due to this, in light L1 which is transmitted through the filter (for example, CF1) having the relatively low refractive index, the light which enters the adjacent filter (for example, CF2) having the relatively high refractive index can be reduced. For example, when assuming that the boundary K12 between the first filter CF1 and the second filter CF2 is provided to be matched with the boundary K between adjacent pixels (FIG. 17), the light LL1 which is obliquely incident on the periphery of the boundary K12 in the first filter CF1 is likely to be incident on the adjacent second filter CF2 as the leakage light. In contrast, according to the embodiment, it is possible to reduce the leakage light.

As described above, according to the display device 1 of the embodiment, it is possible to achieve excellent display performance in which mixed colors and color blurs are reduced without damaging the viewing angle characteristics.

### 2. Second Embodiment

### Configuration of Display Device 2

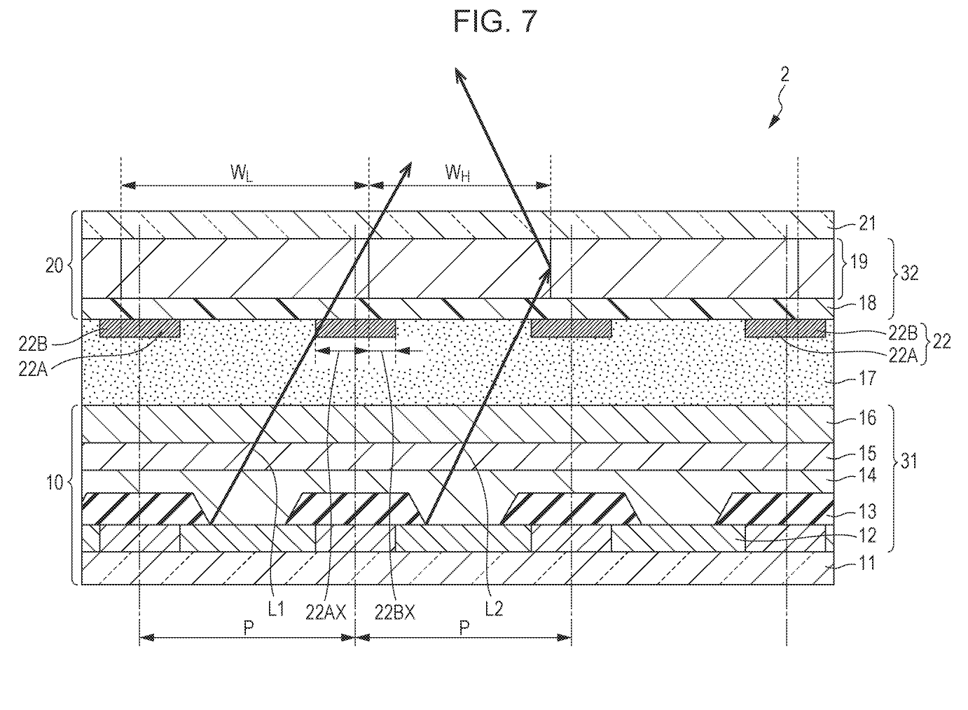

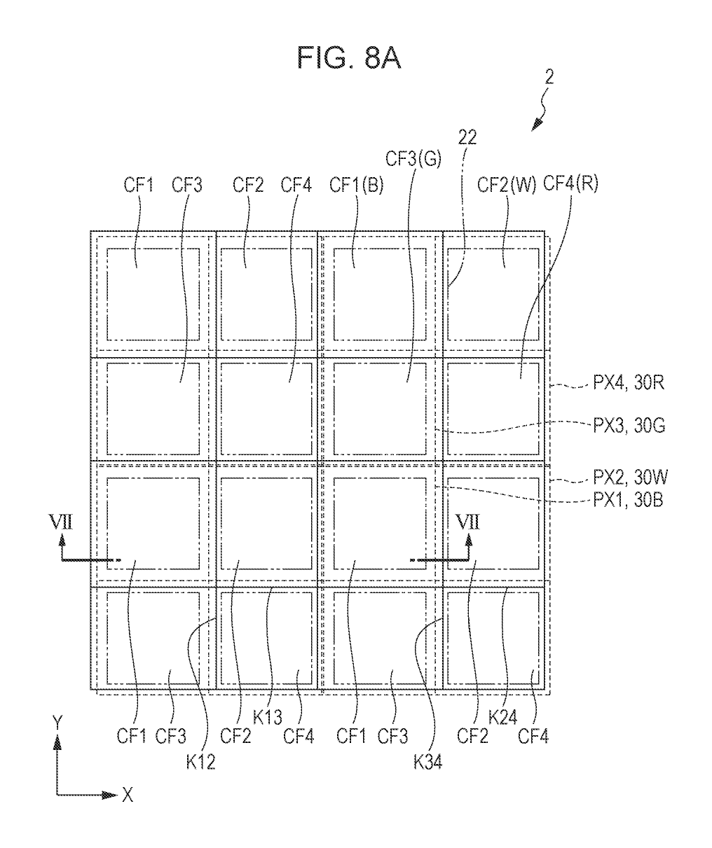

FIG. 7 is a cross-sectional view illustrating main components of an organic EL display device (the display device 2) according to a second embodiment of the disclosure. In addition, FIG. 8A is a top view illustrating the main components of the display device 2, and FIG. 8B is an enlarged top view illustrating a portion of FIG. 8A. The display device 2 has the same configuration as that of the display device 1 of the first embodiment except that a shielding layer 22 is further included. Accordingly, the shielding layer 22 and the associated matters in the following description will be described, and the same constituent element as in the display device 1 is given the same reference numeral, and the description will be appropriately omitted.

As illustrated in FIG. 7, the shielding layer 22 is selectively provided, for example, between the element panel 10 and the sealing panel 20, specifically, on the surface of the overcoat layer 18 which is on the side opposite to the CF layer 19. More specifically, the shielding layer 22 is disposed to straddle the boundary K12 between the first filter CF1 and the second filter CF2, and includes a first shielding portion 22A covering a peripheral edge portion of the first filter CF1 and a second shielding portion 22B covering a peripheral edge portion of the second filter CF2. Here, a dimension 22AX of the first shielding portion 22A in the X axial direction is larger than a dimension 22BX of the second shielding portion 22B in the X axial direction. In addition, the refractive indexes N1 and N2 of the first and second filters CF1 and CF2 are preferably higher than a refractive index of the overcoat layer 18 between the CF layer 19 and the shielding layer 22. This is because that when light is incident on the CF layer 19 from the overcoat layer 18, if the light is refracted in the direction perpendicular to a stacked surface, the light which leaks to the adjacent first filter CF1 or the second filter CF2 by being transmitted through the boundary K12 is reduced.

Similarly, the shielding layer 22 is disposed to straddle a boundary K13 between the first filter CF1 and the third filter CF3, and further includes a third shielding portion 22C covering a peripheral edge portion of a third filter CF3 (FIG. 8B), which is adjacent to the first shielding portion 22A covering the peripheral edge portion of the first filter CF1. Here, a dimension 22AY of the first shielding portion 22A in the Y axial direction is larger than a dimension of 22CY of the third shielding portion 22C in the Y axial direction.

Further, the shielding layer 22 is respectively disposed to straddle a boundary K24 between the second filter CF2 and a fourth filter CF4, and a boundary K34 between the third filter CF3 and the fourth filter CF4. That is, the shielding layer 22 is adjacent to each of the second shielding portion 22B and the third shielding portion 22C, and further includes a fourth shielding portion 22D covering a peripheral edge portion of the fourth filter CF4 (FIG. 8B). Here, a dimension 22BY of the second shielding portion 22B in the Y axial direction is larger than a dimension 22DY of the fourth shielding portion 22D in the Y axial direction. In addition, a dimension 22CX of the third shielding portion 22C in the X axial direction is larger than a dimension 22DX of the fourth shielding portion 22D in the X axial direction.

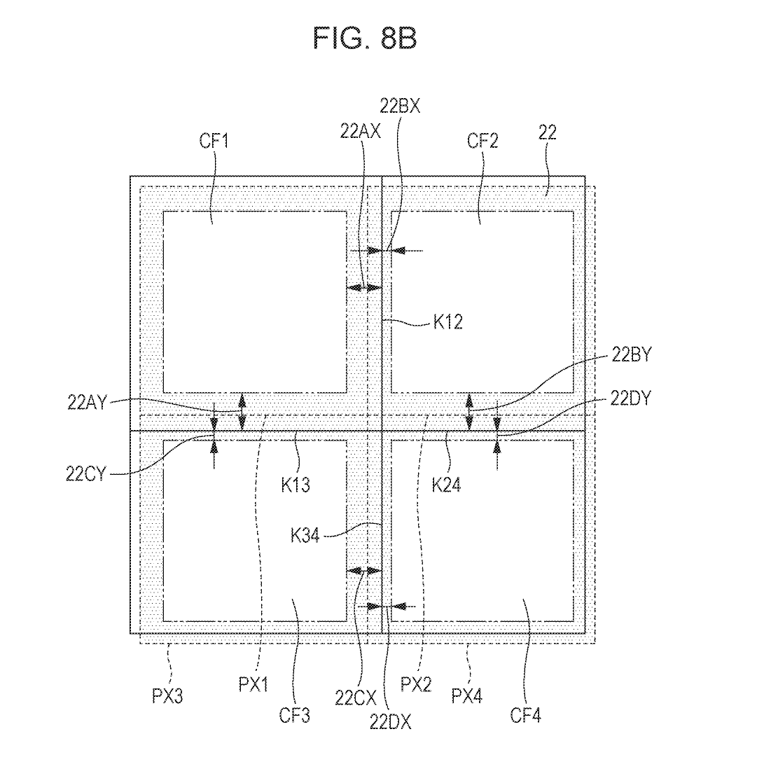

The shielding layer 22 is preferably configured to satisfy the following Condition Expression (2) shown in Formula 5 and Condition Expression (3) shown in Formula 6 (refer to FIG. 9). This is because that a part of the light which is incident on the first filter CF1 from the first pixel PX1 is shielded in the shielding layer 22, and thus is reliably prevented from entering the second filter CF2 from the boundary K12. Note that W₁ represents the width of the shielding layer 22, W_{L} represents the width of the first filter CF1 (that is, the dimension X1 in the X axial direction), W_{H} represents the width of the second filter CF2 (that is, the dimension X2 in the X axial direction), t represents the thickness of the CF layer 19, and θL represents a refracting angle of the light which is incident on the first filter CF1 from the first pixel PX1.

[Formula 5]

W₁+W_{L}≧2t·tan θ_{L}+p (2)

[Formula 6]

p=(W_{L}+W_{H})/2 (3)

Meanwhile, Condition Expression (2) is obtained as follows. First, a refracting angle θ_{L} is illustrated by using Expression (2.1) shown in the following Formula 7 (Snell's law).

$$\begin{matrix}[ Formula 7 ] & \\ {θ}_{L} = {sin}^{- 1} ( \frac{{n}_{1} sin {θ}_{1}}{{n}_{L}} ) & ( 2.1 )\end{matrix}$$

In addition, a condition in which the light incident on the first filter CF1 is not incident on the second filter CF2 without being shielded in the shielding layer 22 is illustrated by using Expression (2.2) shown in the following Formula 8.

$$\begin{matrix}[ Formula 8 ] & \\ t \cdot tan {θ}_{L} \leq \frac{{W}_{1} + {W}_{L} - p}{2} & ( 2.2 )\end{matrix}$$

Condition Expression (2) for preventing a part of the light which is incident on the first filter CF1 (the filter having the relatively low refractive index) from entering the second filter CF2 (the filter having the relatively high refractive index) is lead from the above described Expression (2.2).

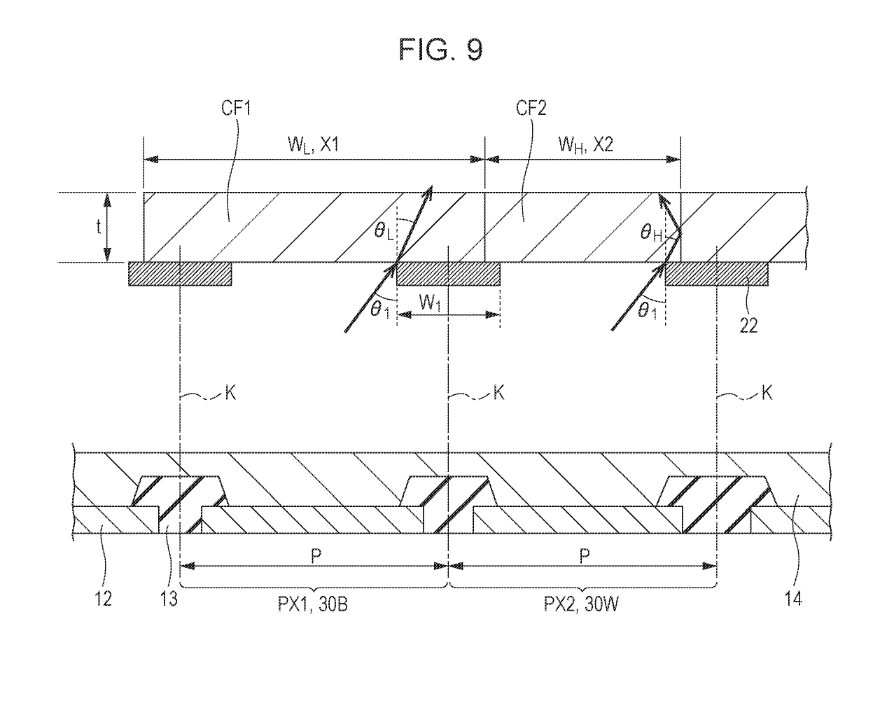

In addition, as illustrated in FIGS. 10A and 10B, in order to set a value of W₁+W_{L} to be small, it is desirable that the thickness of the CF layer 19 is set to be thin, a refractive index nL of the first filter CF1 is set to be high, and the refracting angle θ_{L} (the maximum angle of incidence θ₁) is set to be small. Meanwhile, FIG. 10A is a characteristic diagram illustrating a minimum value of W₁+W_{L} satisfying Condition Expression (2) in the respective levels in which each curved line represents the thickness t of the CF layer 19=2.0 μm, 2.4 μm, 2.8 μm, 3.2 μm, 3.6 μm, and 4.0 μm. In FIG. 10A, the horizontal axis represents the refractive index N₁ (n_{L}), and the vertical axis represents a sum W₁+W_{L} of the width W₁ of the shielding layer 22 and the width W_{L} of the first filter CF1. In addition, FIG. 10B is a characteristic diagram illustrating a minimum value of W₁+W_{L} satisfying Condition Expression (2) in the respective levels in which each curved line represents the maximum angle of incidence θ₁=20°, 25°, 30°, and 35°. In FIG. 10B, the horizontal axis represents the refractive index N₁ (n_{L}), and the vertical axis represents a sum W₁+W_{L} of the width W₁ of the shielding layer 22 and the width W_{L} of the first filter CF1.

### Effects of Display Device 2

In the display device 2, the shielding layer 22 is provided to straddle the boundaries K12, K13, K24, and K34 of the first to fourth filters CF1 to CF4 in the CF layer 19. For this reason, it is possible to prevent the light L₁ which is transmitted through one filter (for example, the first filter CF1) from entering the other adjacent filter (for example, the second filter CF2). Particularly, in a case of satisfying the above described Condition Expression (2) and Condition Expression (3), it is possible to reliably prevent the leakage light. Meanwhile, in the display device 2, it is preferable to satisfy the Condition Expression (1) shown in Formula 1 illustrated in the first embodiment. This is because that the light which is incident on the second filter CF2 from the second pixel PX2 is totally reflected, and thus it is possible to reliably prevent the light from entering the first filter CF1 from the boundary K12.

In addition, in the shielding layer 22, for example, the width 22BX of the second shielding portion 22B which covers the peripheral edge portion of the second filter CF2 having the relatively high refractive index is set to be smaller than the width 22AX of the first shielding portion 22A which covers the peripheral edge portion of the adjacent first filter CF1 having relatively low refractive index. Therefore, it is possible to sufficiently reduce the leakage light and reduce the shielded actinic light, thereby improving the luminance of the display light obtained from the entire display device 2.

### 3. Third Embodiment

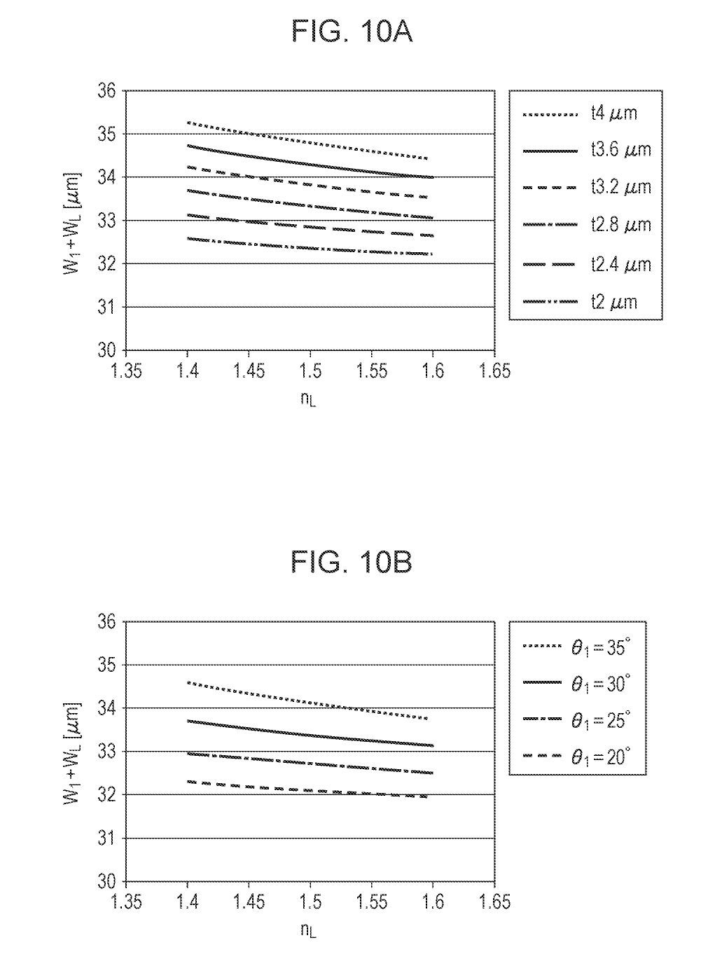

FIG. 11 is a cross-sectional view illustrating main components of a display device (a display device 3) according to a third embodiment of the disclosure.

The display device 3 is a so-called bottom emission type organic EL display device in which the light emitted from the light emitting layer of the organic layer 14 is extracted to the outside by being transmitted through the first electrode layer 12 and the element substrate 11. Accordingly, the first electrode layer 12 is formed of a transparent conductive material such as In—Sn—O, In—Zn—O, In—O, Zn—O, and Al—Zn—O. The element substrate 11 is also formed of a transparent resin in addition to quartz or glass which has optical transparency. On the other hand, the second electrode layer 15 is formed of a simple substance of a metallic element such as, in addition to aluminum, chromium, gold, platinum, nickel, copper, tungsten, and silver, or an alloy thereof, and has a function as a reflecting layer. Except for the aforementioned point, the configuration of the display device 3 is the same as that of the display device 2. In the display device 3, it is possible to obtain the same effect as the above described display device 2.

### 4. Application Example

Hereinafter, the application example of the above described display device (the display devices 1 to 3) to an electronic apparatus will be described. Examples of electronic devices include a television device, portable terminal device such as a digital camera, a notebook personal computer, and a smart phone, or a video camera. That is, the above described display device may be applied to electronic apparatuses in various fields which display an image signal input from the outside or an image signal generated inside as an image or a video.

### Module

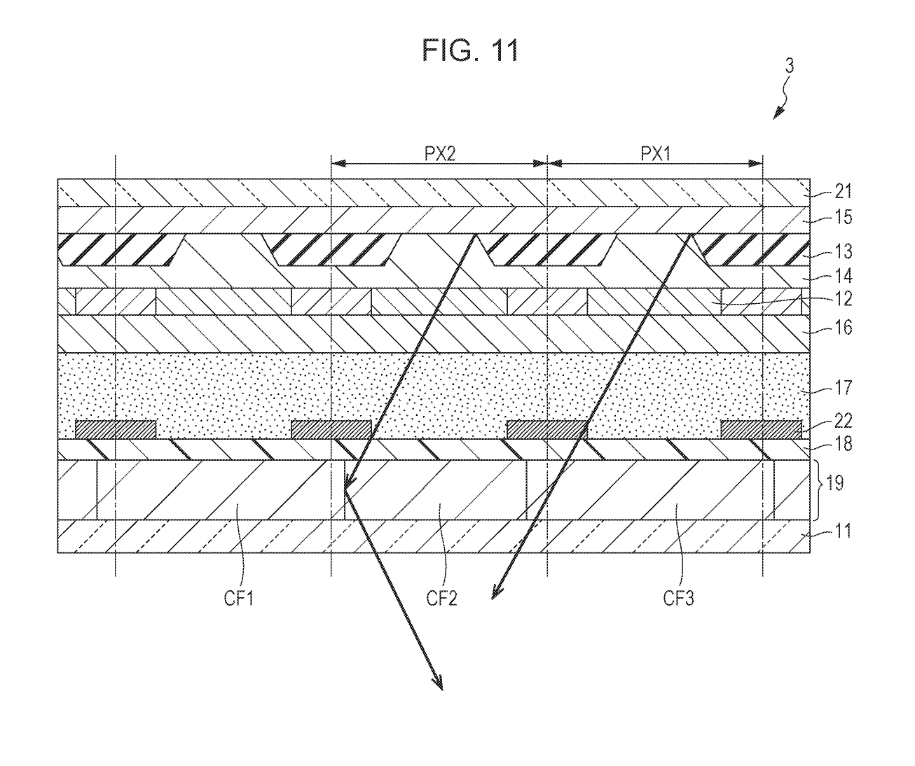

The display device, for example, as a module as illustrated in FIG. 12, is incorporated in various electronic apparatuses including an application example below. The module is provided with, for example, an area 61 exposed from the sealing substrate 21 on one side of the element substrate 11, and an external connecting terminal (a first peripheral electrode, a second peripheral electrode or the like) in the exposed area 61 by extending wirings of a signal line driving circuit 120, a scanning line driving circuit 130, and a power line supply circuit 140. The external connecting terminal may be provided with a flexible printed circuit (FPC) 62 for an input or output of a signal.

### Application Example

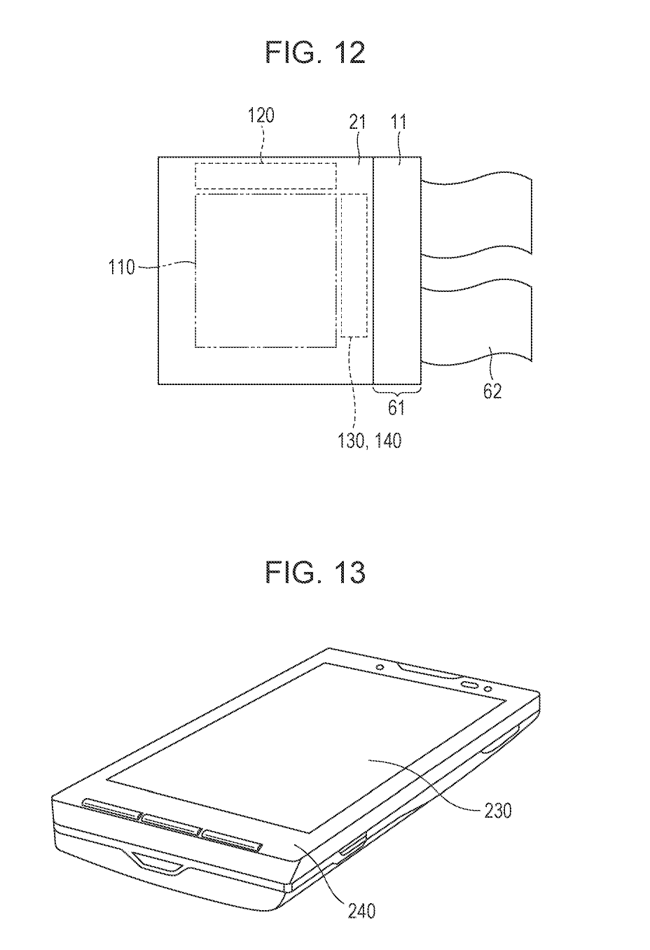

FIG. 13 is a perspective view illustrating an appearance of a smart phone to which the display device of the embodiment is applied. The smart phone includes, for example, a display unit 230 and a non-display unit 240, and the display unit 230 is formed by the display device of the above described embodiment.

### 5. Modification Example

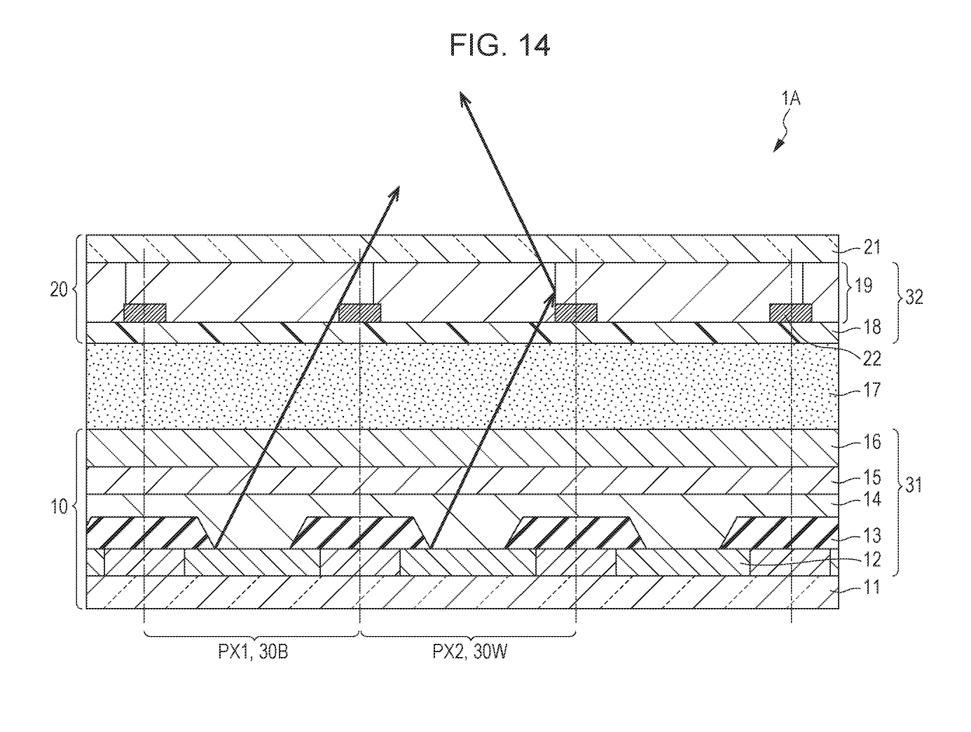

As described above, the present technology is described with some embodiments; however, the technology is not limited to the above described embodiments and may be modified in various ways. For example, in the second embodiment, the shielding layer 22 is provided between the element panel 10 and the sealing panel 20, but the disclosure is not limited to this configuration. For example, the shielding layer 22 may be provided in the CF layer 19 as shown in the display device 1A illustrated in FIG. 14 (the first modification example).

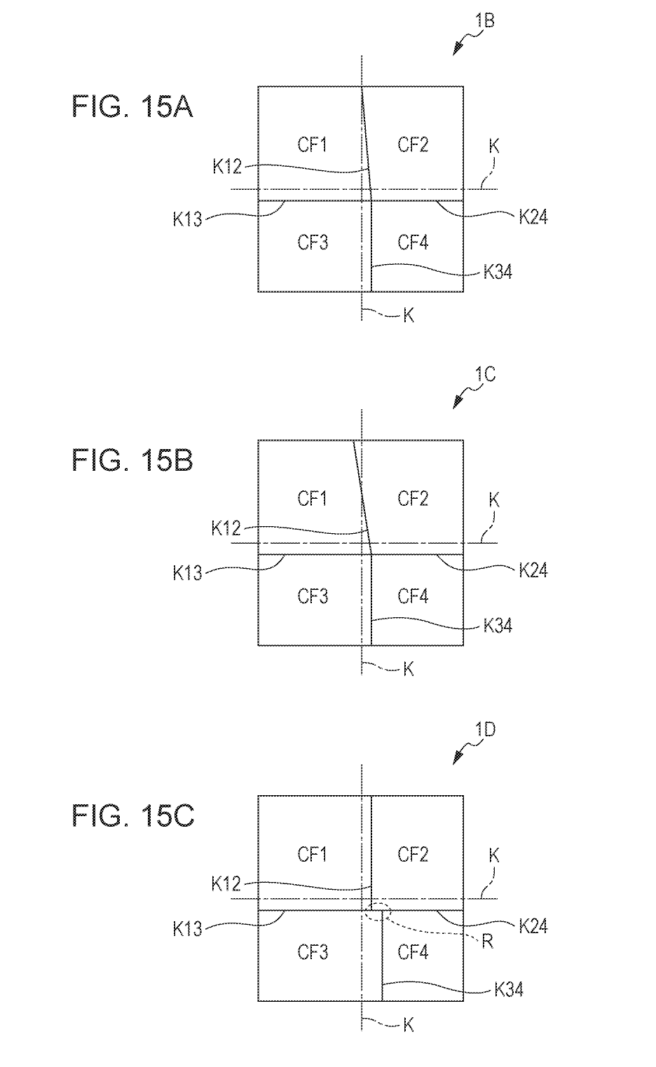

In addition, in the above described embodiment, the case where all of the boundaries K12, K13, K24, and K34 of the first to fourth filters CF1 to CF4 are in parallel with or perpendicular to the boundary K between pixels is described; however, the technology is not limited to this configuration. For example, as shown in the display devices 1B and 1C (the second and third modification examples) in FIGS. 15A and 15B, some boundaries (for example, the boundary K12) may be oblique to the boundary K between pixels. That is, for example, the dimension of at least a part of the first filter CF1 in the X axial direction may be larger than the dimension of the second filter CF2 in the X axial direction, and at least a portion of the boundary K12 may be positioned in an area occupied by the second pixel PX2. Even in this case, it is possible to obtain the effect of reducing the leakage light more than, for example, the case where the boundary K12 is completely matched with the boundary K. Alternatively, as shown in the display device 1D illustrated in FIG. 15C, in the case where all of the boundaries K12, K13, K24, and K34 are in parallel with or perpendicular to the boundary K between pixels, a regions R which does not satisfy the magnitude relationship between the widths or between the refraction indexes in the filters may exist in a predetermined part.

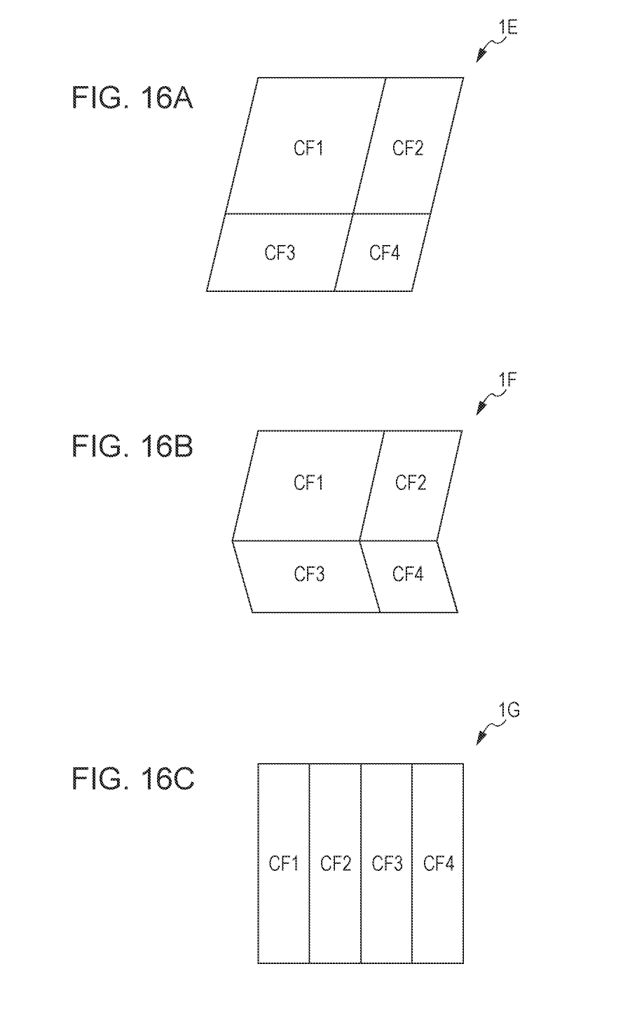

In addition, in the above described embodiment, the case where the first to fourth filters CF1 to CF4 are disposed in a rectangle manner in response to the arrangement of the organic light emitting elements 10R, 10G, 10B, and 10W is described; however, the technology is not limited to this configuration. For example, as shown in the display device 1E in illustrated FIG. 16A, the first to fourth filters CF1 to CF4 may be formed into a parallelogram as a whole (a fifth modification example). In addition, as shown in the display device 1F illustrated in illustrated FIG. 16B, the filters may be formed into a curved shape as a whole by combining a parallelogram formed of the first and second filters CF1 and CF2 with a parallelogram formed of the third and fourth filters CF3 and CF4 (a sixth modification example). Further, as shown in the display device 1G illustrated in FIG. 16C, the first to fourth filters CF1 to CF4 may be arranged in a stripe manner (a seventh modification example). In the case of FIG. 16C, the respective refractive indexes of the first and third filters CF1 and CF3 may be different from the refractive indexes of the second and fourth filters CF2 and CF4.

In addition, the above described embodiments, an example of the substructure of each of the organic light emitting elements which emits white light is described; however the technology is not limited to this example. For example, each of the red organic light emitting element, the green organic light emitting element, the blue organic light emitting element, and the white organic light emitting element may have a structure which emits red light, green light, blue light, and white light. That is, a plurality of organic layer including each light emitting layer which emits the red light, the green light, the blue light, and the white light may be divided into each pixel. Even in that case, since each color filter is used in order to improve color purity, the present technology is effective.

Further, in the above described embodiments, the case of the active matrix-type display device is described, but the technology can be applied to a passive matrix type display device. In addition, the configuration of the pixel driving circuit for driving the active matrix is not limited to the description of the above embodiments, and the capacitance element or the shift transistor may be properly added thereto. In that case, in addition to the aforementioned signal line driving circuit 120 or the scanning line driving circuit 130, another driving circuit may be added in response to the change of the pixel driving circuit.

In addition, the effects described in the specification are merely illustrative and are not limited to the above description, and there may be other effects. The present technology can also take the following configurations

(1)

A display device including:

a display unit that includes a first pixel and a second pixel which are adjacent to each other in a first direction; and

a filter layer that includes a first filter and a second filter which are disposed corresponding to each of the first pixel and the second pixel, and which are adjacent to each other in the first direction,

wherein a refractive index of the first filter is lower than a refractive index of the second filter,

wherein a dimension of at least a part of the first filter in the first direction is larger than a dimension of the second filter in the first direction, and

wherein at least a portion of a boundary between the first filter and the second filter is positioned in an area occupied by the second pixel.

(2)

The display device according to the description (1), further including:

a shielding layer that includes a first light shielding portion which occupies an area corresponding to a peripheral edge portion of the first filter and a second light shielding portion which occupies an area corresponding to a peripheral edge portion of the second filter, which are disposed at the boundary between the first filter and the second filter,

wherein a dimension of at least a part of the first light shielding portion in the first direction is larger than a dimension of the second light shielding portion in the first direction.

(3)

The display device according the description (1),

wherein the display unit further includes a third pixel which is adjacent to the first pixel in a second direction,

wherein the filter layer further includes a third filter which is disposed corresponding to the third pixel so as to be adjacent to the first filter in the second direction,

wherein the refractive index of the first filter is lower than a refractive index of the third filter,

wherein the dimension of at least a part of the first filter in the second direction is larger than a dimension of the third filter in the second direction, and

wherein at least a portion of a boundary between the first filter and the third filter is positioned in an area occupied by the third pixel.

(4)

The display device according to the description (3),

wherein the display unit further includes a fourth pixel which is adjacent to the third pixel in the first direction and which is adjacent to the second pixel in the second direction,

wherein the filter layer further includes a fourth filter which is disposed corresponding to the fourth pixel so as to be adjacent to the third filter in the first direction and adjacent to the second filter in the second direction,

wherein a refractive index of the fourth filter is higher than the refractive indexes of both second and third filters,

wherein a dimension of at least a part of the fourth filter in the first direction is smaller than the dimension of the third filter in the first direction,

wherein at least a portion of a boundary between the third filter and the fourth filter is positioned in an area occupied by the fourth pixel,

wherein a dimension of at least a part of the fourth filter in the second direction is smaller than the dimension of the second filter in the second direction, and

wherein at least a portion of a boundary between the second filter and the fourth filter is positioned in an area occupied by the fourth pixel.

(5)

The display device according to the description (3), further including:

a shielding layer that includes a first light shielding portion which occupies an area corresponding to a peripheral edge portion of the first filter and a third light shielding portion which occupies an area corresponding to a peripheral edge portion of the third filter, which are disposed at a boundary between the first filter and the third filter, and

wherein a dimension of at least a part of the first light shielding portion in the second direction is larger than a dimension of the third light shielding portion in the second direction.

(6)

The display device according to the description (4), further including:

a shielding layer that includes a first light shielding portion which occupies an area corresponding to a peripheral edge portion of the first filter, a second light shielding portion which occupies an area corresponding to a peripheral edge portion of the second filter, a third light shielding portion which occupies an area corresponding to a peripheral edge portion of the third filter, and a fourth light shielding portion which occupies an area corresponding to a peripheral edge portion of the fourth filter, each of which is disposed at the boundary between the first filter and the second filter, the boundary between the first filter and the third filter, the boundary between the second filter and the fourth filter, and the boundary between the third filter and the four filter,

wherein a dimension of at least a part of the first light shielding portion in the first direction is larger than a dimension of the second light shielding portion in the first direction,

wherein a dimension of at least a part of the third light shielding portion in the first direction is larger than a dimension of the fourth light shielding portion in the first direction,

wherein a dimension of at least a part of the first light shielding portion in the second direction is larger than a dimension of the third light shielding portion in the second direction, and

wherein the dimension of at least a part of the second light shielding portion in the second direction is larger than the dimension of the fourth light shielding portion in the second direction.

(7)

The display device according to any one of the descriptions (2), (5), and (6),

wherein the shielding layer is provided between the filter layer and the display unit, or provided inside the filter layer.

(8)

The display device according to any one of the descriptions (2), (5), and (6), further including:

a resin layer between the filter layer and the shielding layer,

wherein a refractive index of the filter layer is higher than a refractive index of the resin layer.

(9)

The display device satisfying Conditional Expression (1) shown in the following Formula 9 according to any one of the descriptions (1) to (8),

$$\begin{matrix}[ Formula 9 ] & \\ {sin}^{- 1} ( \frac{{n}_{1}}{{n}_{H}} sin {θ}_{1} ) + {sin}^{- 1} ( \frac{{n}_{L}}{{n}_{H}} ) ≦ \frac{π}{2} & ( 1 )\end{matrix}$$

wherein n₁ represents a refractive index of a medium through which light passes immediately before being incident on the second filter from the second pixel, n_{H} represents a refractive index of the second filter, θ₁ represents a maximum angle of incidence of the light which is incident on the second filter from the second pixel, and n_{L} represents a refractive index of the first filter.

(10)

The display device satisfying Conditional Expressions (2) and (3) shown in the following Formulae 10 and 11 according to any one of the descriptions (2), (5), and (8),

[Formula 10]

W₁+W_{L}≧2t·tan θ_{L}+p (2)

[Formula 11]

p=(W_{L}+W_{H})/2 (3)

wherein W₁ represents a width of the shielding layer, W_{L} represents a width of the first filter, W_{H} represents the width of the second filter, and t represents a thickness of the filter layer, θ_{L} represents a refracting angle of the light which is incident on the first filter from the first pixel.

(11)

An electronic apparatus including: a display device,

wherein the display device includes

a display unit that includes a first pixel and a second pixel which are adjacent to each other in a first direction, and

a filter layer that includes a first filter and a second filter are disposed corresponding to each of the first pixel and the second pixel, and which are adjacent to each other in the first direction,

wherein, in the display device, a refractive index of the first filter is lower than a refractive index of the second filter,

wherein a dimension of at least a part of the first filter in the first direction is larger than a dimension of the second filter in the first direction, and

wherein, in the display device, at least a portion of a boundary between the first filter and the second filter is positioned in an area occupied by the second pixel.

(12)

The electronic apparatus according to the description

wherein the display device further includes

a shielding layer that includes a first shielding portion which covers a peripheral edge portion of the first filter and a second shielding portion which covers a peripheral edge portion of the second filter, which are disposed at the boundary between the first filter and the second filter, and

wherein a dimension of at least a part of the first shielding portion in the first direction is larger than a dimension of the second shielding portion in the first direction.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit that includes a first pixel and a second pixel which are adjacent to each other in a first direction; and
a filter layer that includes a first filter and a second filter which are disposed corresponding to each of the first pixel and the second pixel, and which are adjacent to each other in the first direction,
wherein a refractive index of the first filter is lower than a refractive index of the second filter,
wherein a dimension of at least a part of the first filter in the first direction is larger than a dimension of the second filter in the first direction, and
wherein at least a portion of a boundary between the first filter and the second filter is positioned in an area occupied by the second pixel.

2. The display device according to claim 1, further comprising:
a shielding layer that includes a first light shielding portion which occupies an area corresponding to a peripheral edge portion of the first filter and a second light shielding portion which occupies an area corresponding to a peripheral edge portion of the second filter, which are disposed at the boundary between the first filter and the second filter,
wherein a dimension of at least a part of the first light shielding portion in the first direction is larger than a dimension of the second light shielding portion in the first direction.

3. The display device according to claim 1,
wherein the display unit further includes a third pixel which is adjacent to the first pixel in a second direction,
wherein the filter layer further includes a third filter which is disposed corresponding to the third pixel so as to be adjacent to the first filter in the second direction,
wherein the refractive index of the first filter is lower than a refractive index of the third filter,
wherein the dimension of at least a part of the first filter in the second direction is larger than a dimension of the third filter in the second direction, and
wherein at least a portion of a boundary between the first filter and the third filter is positioned in an area occupied by the third pixel.

4. The display device according to claim 3,
wherein the display unit further includes a fourth pixel which is adjacent to the third pixel in the first direction and which is adjacent to the second pixel in the second direction,
wherein the filter layer further includes a fourth filter which is disposed corresponding to the fourth pixel so as to be adjacent to the third filter in the first direction and adjacent to the second filter in the second direction,
wherein a refractive index of the fourth filter is higher than the refractive indexes of both second and third filters,
wherein a dimension of at least a part of the fourth filter in the first direction is smaller than the dimension of the third filter in the first direction,
wherein at least a portion of a boundary between the third filter and the fourth filter is positioned in an area occupied by the fourth pixel,
wherein a dimension of at least a part of the fourth filter in the second direction is smaller than the dimension of the second filter in the second direction, and
wherein at least a portion of a boundary between the second filter and the fourth filter is positioned in an area occupied by the fourth pixel.

5. The display device according to claim 3, further comprising:
a shielding layer that includes a first light shielding portion which occupies an area corresponding to a peripheral edge portion of the first filter and a third light shielding portion which occupies an area corresponding to a peripheral edge portion of the third filter, which are disposed at a boundary between the first filter and the third filter, and
wherein a dimension of at least a part of the first light shielding portion in the second direction is larger than a dimension of the third light shielding portion in the second direction.

6. The display device according to claim 4, further comprising:
a shielding layer that includes a first light shielding portion which occupies an area corresponding to a peripheral edge portion of the first filter, a second light shielding portion which occupies an area corresponding to a peripheral edge portion of the second filter, a third light shielding portion which occupies an area corresponding to a peripheral edge portion of the third filter, and a fourth light shielding portion which occupies an area corresponding to a peripheral edge portion of the fourth filter, each of which is disposed at the boundary between the first filter and the second filter, the boundary between the first filter and the third filter, the boundary between the second filter and the fourth filter, and the boundary between the third filter and the four filter,
wherein a dimension of at least a part of the first light shielding portion in the first direction is larger than a dimension of the second light shielding portion in the first direction,
wherein a dimension of at least a part of the third light shielding portion in the first direction is larger than a dimension of the fourth light shielding portion in the first direction,
wherein a dimension of at least a part of the first light shielding portion in the second direction is larger than a dimension of the third light shielding portion in the second direction, and
wherein the dimension of at least a part of the second light shielding portion in the second direction is larger than the dimension of the fourth light shielding portion in the second direction.

7. The display device according to claim 2,
wherein the shielding layer is provided between the filter layer and the display unit, or provided inside the filter layer.

8. The display device according to claim 2, further comprising:
a resin layer between the filter layer and the shielding layer,
wherein a refractive index of the filter layer is higher than a refractive index of the resin layer.

9. The display device satisfying Conditional Expression (1) shown in the following Formula 1 according to claim 1,
$$\begin{matrix}[ Formula 1 ] & \\ {sin}^{- 1} ( \frac{{n}_{1}}{{n}_{H}} sin {θ}_{1} ) + {sin}^{- 1} ( \frac{{n}_{L}}{{n}_{H}} ) ≦ \frac{π}{2} & ( 1 )\end{matrix}$$
wherein n₁ represents a refractive index of a medium through which light passes immediately before being incident on the second filter from the second pixel, n_{H} represents a refractive index of the second filter, θ₁ represents a maximum angle of incidence of the light which is incident on the second filter from the second pixel, and n_{L} represents a refractive index of the first filter.

10. The display device satisfying Conditional Expressions (2) and (3) shown in the following Formulae 2 and 3 according to claim 2,
[Formula 2]
W₁+W_{L}≧2t·tan θ_{L}+p (2)
[Formula 3]
p=(W_{L}+W_{H})/2 (3)
wherein W₁ represents a width of the shielding layer, W_{L} represents a width of the first filter, W_{H} represents the width of the second filter, and t represents a thickness of the filter layer, θ_{L} represents a refracting angle of the light which is incident on the first filter from the first pixel.

11. An electronic apparatus comprising: a display device,
wherein the display device includes
a display unit that includes a first pixel and a second pixel which are adjacent to each other in a first direction, and
a filter layer that includes a first filter and a second filter which are disposed corresponding to each of the first pixel and the second pixel, and which are adjacent to each other in the first direction,
wherein, in the display device, a refractive index of the first filter is lower than a refractive index of the second filter,
wherein a dimension of at least a part of the first filter in the first direction is larger than a dimension of the second filter in the first direction, and
wherein, in the display device, at least a portion of a boundary between the first filter and the second filter is positioned in an area occupied by the second pixel.

12. The electronic apparatus according to claim 11,
wherein the display device further includes
a shielding layer that includes a first shielding portion which covers a peripheral edge portion of the first filter and a second shielding portion which covers a peripheral edge portion of the second filter, which are disposed at the boundary between the first filter and the second filter, and
wherein a dimension of at least a part of the first shielding portion in the first direction is larger than a dimension of the second shielding portion in the first direction.
